(19) United States
(12) Patent Application Publication
(10) Pub. No.: US 2003/0028813 A1
(43) Pub. Date: Feb. 6, 2003

(54) Security for standalone systems running dedicated application

(75) Inventor: Craig Lewis, Austin, TX (US)

Correspondence Address: Russell N. Rippamonti, Esq-, Jenkens & Gilchrist, P.C., 3200 Fountain Place, 1445 Ross Avenue, Dallas, TX, 75202-2799, US

(73) Assignee: DRESSER, INC.

(21) Appl. No.: 09/922,178

(22) Filed: Aug. 2, 2001

(51) Int. Cl. H04L 9/00

(52) U.S. Cl. 713/202

(57) ABSTRACT

According to one illustrative embodiment, a standalone computer system having a password maintenance capability includes an operating system, a password generator, and a password encryptor. The operating system is operable for executing a dedicated application. The password security generator couples with the operating system for generating a password in response to an occurrence of a prescribed password generation event, in connection with the operating system and the dedicated application. Lastly, the password encryptor couples to the password generator for producing a coded password as a function of the generated password.

The present embodiments relate to a method and system of password security for standalone computer systems running a respective dedicated application.

### BACKGROUND

In a fuel dispensing and retail sales environment, standalone computer systems are used for executing a dedicated application. The standalone computer systems need to be secure while still allowing service personnel access when required. Moreover, a group of networked computers operating in a standalone mode for executing a dedicated application also need to be secure.

Typically, service personnel are issued a common password to facilitate an ability to access a number of such standalone computer systems for service. A shortcoming of such a method is that the password is remotely administered for each computer system and a password database is maintained. Password security could easily be compromised.

Accordingly, there is a need to overcome the shortcomings associated with the typical method for password security in standalone computer systems executing a dedicated application and for providing improved password security.

### SUMMARY

According to one illustrative embodiment, a standalone computer system having a password maintenance capability includes an operating system, a password generator, and a password encryptor. The operating system is operable for executing a dedicated application. The password security generator couples with the operating system for generating a password in response to an occurrence of a prescribed password generation event, in connection with the operating system and the dedicated application. Lastly, the password encryptor couples to the password generator for producing a coded password as a function of the generated password.

### BRIEF DESCRIPTION OF THE DRAWINGS

FIG. 1 is a diagrammatic view of an embodiment of the password security method and password security for use in a standalone computer system in a fuel dispensing/retail sale environment running a dedicated application;

FIG. 2 is a diagrammatic view of the operating system password security coupled with the dedicated application of FIG. 1 in further detail;

FIG. 3 is a block diagram view of a password security generator according to one embodiment of the present disclosure;

FIG. 4 is a block diagram view of a password provider according to one embodiment of the present disclosure;

FIG. 5 is an exemplary view of an operating system login screen for use when implementing the method and system security according to the present embodiments; and

FIG. 6 is an exemplary view of a dedicated application login screen for use with the method and system security according to the present embodiments.

### DETAILED DESCRIPTION

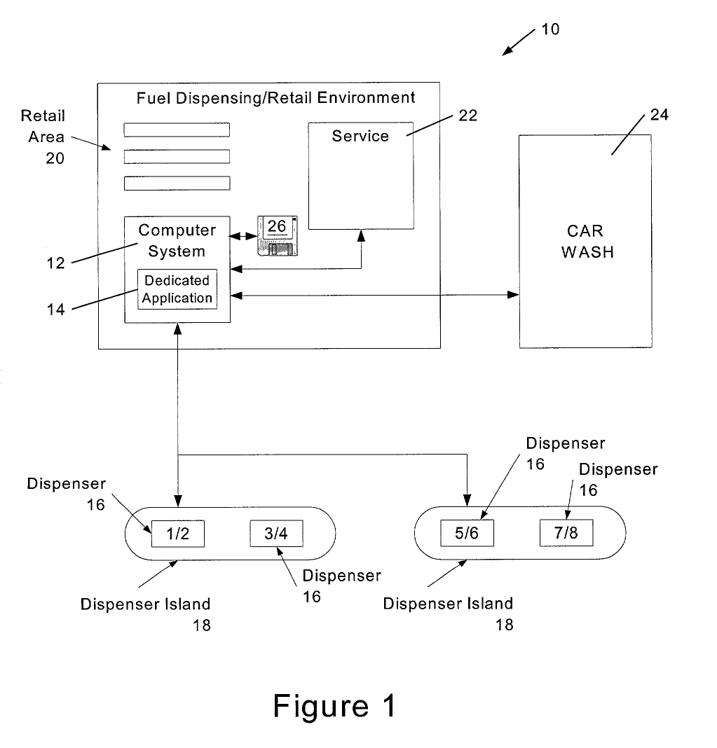

Referring to FIG. 1, a diagrammatic view of an illustrative embodiment of password security in a standalone computer system is shown. In particular, the illustrative embodiment includes a fuel dispensing and retail sale environment 10 having a computer system 12 for executing a dedicated application 14.

In one embodiment, the dedicated application 14 for the fuel dispensing and retail sale environment includes a point-of-sale (POS) application. The dedicated application administers fuel dispensing from one of a plurality of fuel dispensers 16. Dispenser islands 18 contain one or more fuel dispensers 16 for use in the dispensing of fuel, each dispenser having one or more dispensing positions. The dedicated application 14 can further handle retail sales of merchandise from a retail area 20, service from a service area 22, and other services, for example, a car wash 24. Computer system 12 couples with the various components of the fuel dispensing and retail sale environment 10 for carrying out prescribed functions discussed further hereinbelow.

The password security method and system apparatus of the illustrative embodiments are implemented on computer system 12 for performing various functions as described hereinbelow. Computer system 12 includes at least one central processing unit (CPU) for executing instructions for causing the computer system to perform the various functions. Inputs may include any input entered via an input device, such as a keyboard, interface card, or other suitable input device. The computer system further includes mass storage having fixed and/or removable computer readable media 26, for example, diskette, hard drive, CD ROM, or other available mass storage technology.

Computer programs and data are generally stored as instructions and data in mass storage until loaded into a computer main memory for execution. The various functions discussed hereinbelow can be programmed using programming techniques well known in the art.

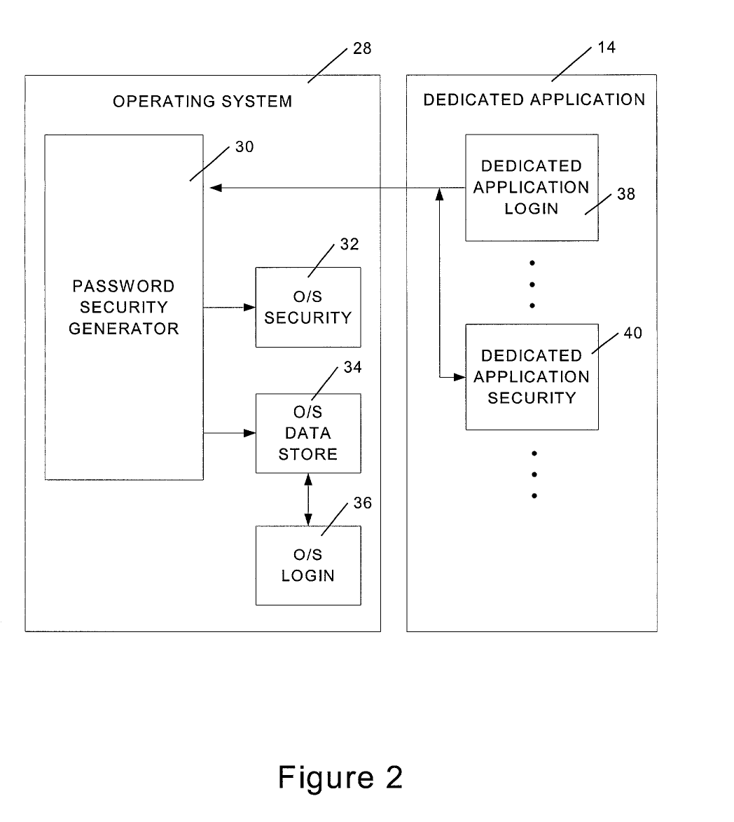

FIG. 2 illustrates a diagrammatic view of an operating system 28 of the computer 12 of FIG. 1 having password security coupled with the dedicated application 14. The operating system 28 includes security features having a password security generator 30, an operating system security module 32, an operating system data store 34 and an operating system login module 36. The dedicated application 14 includes at least a dedicated application login module 38 and a dedicated application security module 40.

As illustrated, the password security generator 30 receives input from the dedicated application login module 38 and the dedicated application security module 40. Password security generator 30 provides outputs to the O/S security module 32 and the O/S data store 34. The O/S security module 32 includes a conventional security module for an operating system having security features, for example, Windows NT™. The O/S data store 34 includes, for example, a registry. Furthermore, the O/S data store 34 couples with the O/S login module 36 for transferring data therebetween. Interaction of the operating system and dedicated application are discussed further hereinbelow.

Password Security Generator

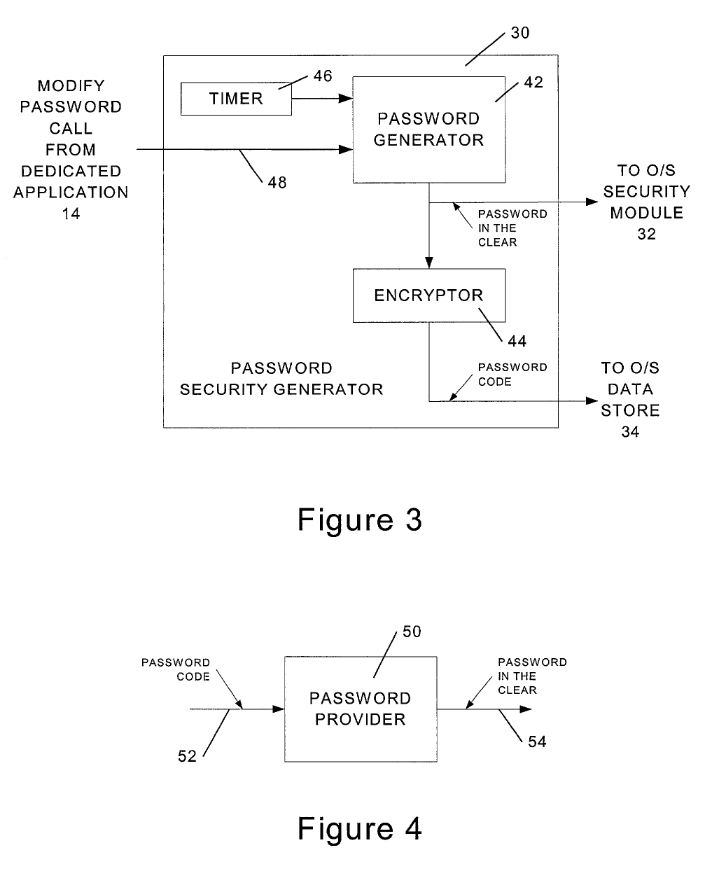

Referring now to FIG. 3, password security generator 30 includes at least a password generator module 42 and an encryptor 44. Password generator module 42 receives inputs, for example, from timer 46 or a modify password call input 48 from the dedicated application 14. Responsive to a prescribed modify password event, password generator outputs a password in the clear to the O/S security module 32 and to the encryptor 44. In response to receiving the password from password generator, the encryptor 44 produces a password code. Encryptor 44 outputs the password code to the O/S data store 34.

In one embodiment, the encryptor of the password security generator uses a prescribed algorithm to encrypt passwords. For example, the encryptor uses a one shot encryption algorithm. In another embodiment, the encryptor uses a Data Encryption Standard (DES) algorithm to make the encrypted password more secure.

According to another embodiment, the password security generator 30 involves a background process that initiates upon a start up of the operating system 28. During the background process, the password security generator periodically wakes up and modifies the password for the system administrator user (e.g., the username “Service). For the periodic wake up, timer 46 provides a signal to the password generator 42 for initiating generation of a new password. The password generator 42 is also activated upon operating system startup, for example, via a modify password call. Furthermore, the dedicated application includes at least one instruction and/or action for ensuring that the background process provided by the password generator remains running. Upon generation of a new password from the password generator, the password encryptor generates a password code. The password code includes a data string for use in deriving the actual password, as described further hereinbelow.

Password Provider

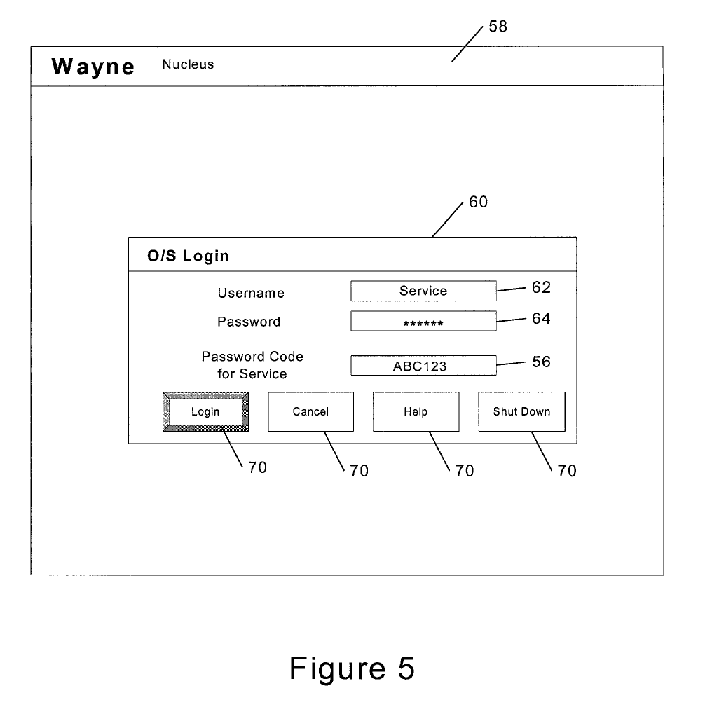

Referring now to FIG. 4, the illustrative embodiments include use of a password provider 50 for outputting a password in the clear 54 in response to an input of a password code 52. The password provider 50 includes a suitable means for generating the actual password in response to an input of the password code, such as displayed upon the operating system login screen, as discussed further hereinbelow with reference to FIG. 5.

For example, the password provider includes a software utility for taking the password code and generating the password as a function of the password code. Moreover, the password provider includes a command line utility that takes the encrypted password as a parameter and outputs the equivalent password. The password provider uses the same algorithm that the password security generator uses. According to one embodiment, a secure central office administrator or helpdesk maintains possession and utilization of the password provider.

Operating System Login

Referring now to FIG. 5, according to the illustrative embodiments, the operating system login process includes instructions for displaying the password code generated by the password generator. For example, the operating system login process displays the password code 56 on an operating system login screen 58. The operating system login screen 58 includes a dialog box 60 for inputting a username 62 and password 64. The dialog box 60 also includes one or more action buttons 70, for example, login, cancel, help, and shut down. The operating system executes a suitable action in response to selection of a respective action button.

Dedicated Application Login

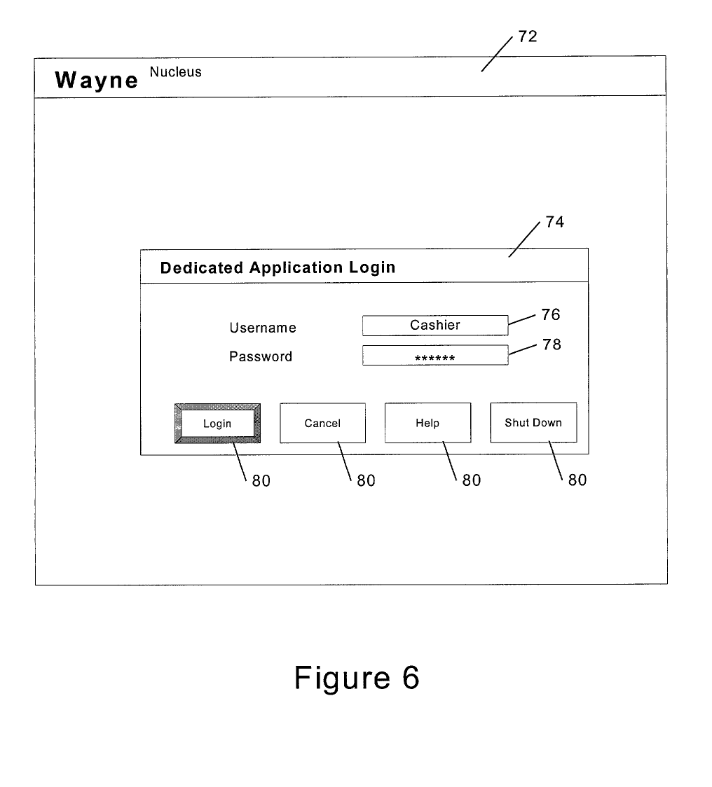

Referring now to FIG. 6, according to the illustrative embodiments, the dedicated application login process includes instructions for displaying a login screen 72. The dedicated login screen 72 includes a dialog box 74 for inputting a username 76 and password 78. The dialog box 74 also includes one or more action buttons 80, for example, login, cancel, help, and shut down. The dedicated application executes a suitable action in response to selection of a respective action button.

According to one embodiment, a method for maintaining a password in a computer system equipped with an operating system for running a dedicated application includes generating a password in response to an occurrence of a prescribed password generation event. The password generation can include generating a password for a prescribed username. According to one embodiment, the prescribed username includes a service username. Moreover, the generated password is provided to an operating system security module, and can include the overwriting a previously generated password.

The method also includes producing a coded password as a function of the generated password. The coded password is stored for use in connection with a secure operating system login access. Storing the coded password includes overwriting a previously stored coded password.

The method further includes displaying the stored coded password during an operating system login. The displayed coded password is subject to being decoded with the use of a corresponding secure password provider. The secure operating system login is responsive to an input of a correctly decoded coded password for enabling access to the operating system as a function of the generated password and the operating system security module.

Example password generation events include at least one of a computer system power-up, a computer system re-boot, expiration of a prescribed time duration from an immediately preceding password generation event, restoration of a security level from a modified security level to a default security level, and occurrence of a secure operating system login access. The modified security level of a password generation event includes at least one of a change in the security level within the dedicated application, a security level override within the dedicated application, and a one-shot security access within the dedicated application.

The method further includes searching a username registry of the dedicated application upon the occurrence of the prescribed password generation event. Any invalid usernames are removed from the username registry. The search also includes reviewing of privileges associated with respective valid usernames in the username registry and resetting the privileges of the respective valid username to prescribed default settings.

According to another embodiment, a computer system having a password maintenance capability includes an operating system and a password security generator. The operating system includes a security module, an operating system data store module, and an operating system login module. The operating system is operable for executing a dedicated application.

The password security generator including a password generator and a password encryptor. The password generator couples with the operating system for generating a password in response to an occurrence of a prescribed password generation event. The password generator also provides the generated password to the operating system security module. In one embodiment, the password generator provides the generated password to the operating system security module and overwrites a previously generated password.

The password encryptor couples to the password generator for producing a coded password as a function of the generated password. The password encryptor provides the coded password to the operating system data store module for use in connection with a secure operating system login access via the operating system login module. In one embodiment, the password encryptor stores the coded password and overwrites a previously stored coded password.

The computer system further includes a means for displaying the stored coded password during an operating system login, for example, via a login screen. The coded password displayed can then be decoded with the use of a corresponding secure password provider. The operating system login module is responsive to an input of a correctly decoded coded password for enabling access to the operating system as a function of the generated password and the operating system security module.

According to yet another illustrative embodiment, a computer program product for maintaining a password in a computer system equipped with an operating system for running a dedicated application includes a computer program processable by a computer system for causing the computer system to: generate a password in response to an occurrence of a prescribed password generation event, provide the generated password to an operating system security module, produce a coded password as a function of the generated password, and store the coded password for use in connection with a secure operating system login access. Apparatus is also provided from which the computer program is accessible by the computer system.

The computer program of the computer program product is further processable by the computer system for causing the computer system to display the stored coded password during an operating system login. Accordingly, the displayed coded password is subject to being decoded with the use of a corresponding secure password provider. The secure operating system login is responsive to an input of a correctly decoded coded password for enabling access to the operating system as a function of the generated password and the operating system security module.

Prescribed password generation events can include a computer system power-up, a computer system re-boot, expiration of a prescribed time duration from an immediately preceding password generation event, restoration of a security level from a modified security level to a default security level, or occurrence of a secure operating system login access. Examples of a modified security level can include a change in security level within the dedicated application, a security level override within the dedicated application, and a one-shot security access within the dedicated application.

In addition, the computer program is further processable by the computer system for causing the computer system to search a username registry of the dedicated application upon the occurrence of the prescribed password generation event and remove any invalid usernames from the username registry. The computer program further includes a review of privileges associated with respective valid usernames in the username registry and resetting the privileges of the respective valid usernames to prescribed default settings.

Operation

In operation, when a standalone system requires service, a service engineer travels to the particular site. The service engineer shuts down the dedicated application and returns the computer system to the operating system login process. As discussed herein above, the operating system password for the system administrator (e.g., the username “Service”) changes periodically in response to one of a number of password change events. Accordingly, the service engineer would need to determine the current password. To do so, the service engineer contacts a central secure facility, provides the password code, and then obtains the password necessary for gaining access to the operating system.

The central secure facility maintains control over the password provider. Using the password provider, the central secure facility generates a password in response to an input of the password code. Upon a generation of the password, the central secure facility provides the same to the service engineer. The password provided by the central secure facility enables the service engineer to access the operating system for performing any required maintenance. The password provided by the central secure facility remains valid until the occurrence of a subsequent password change event, for example, until the operating system is restarted. Note however, upon occurrence of one of the number of password change events, the system administrator password changes. Accordingly, the standalone system is rendered more secure than without the benefit of the present embodiments.

According to the present embodiments, a password generator secure procedure includes generating a new password and a corresponding password code. In one embodiment, the password generator updates the password of username “Service” for a service engineer account. Also, the password generator secure procedure includes instructions for searching the username registry and removing any invalid usernames from the system. With the dedicated application, the valid usernames are known. Accordingly, the password generator can readily identify any invalid usernames and remove the same from the operating system password security registry.

Additionally, the password generator secure procedure includes verifying privileges of the valid users of the system. That is, the procedure verifies that there have been no changes in privileges to valid users of the system. If changes to privileges are uncovered, then the invalid privileges are removed and valid privileges restored. The privileges are restored to the default privileges for all users. Alternatively, rather than verifying any changes in user privileges, the password generator secure procedure restores privileges to the default privileges of each respective valid system user.

### EXAMPLE

According to yet another embodiment, the password security method executes in the base operating system application to allow all applications of the standalone computer system operating from the base to take advantage of extra security. The base operating system can include Windows NT™, for example. In one embodiment, the password security functionality makes use of the Microsoft GINA DLL/winlogon.exe interface. DLL represents Dynamic Link Library. GINA represents Graphical Identification and Authentication. GINA is the DLL that the winlogon.exe in Windows NT uses to control user identification and authentication. MSDN represents Microsoft Developer Network. In addition, the password security generator and the password provider both utilize DES.

The password security generator process includes an NT service set up as a COM server. The COM server exposes an interface with a single method, for example, modifyPassword and take no parameters.

When the service starts up, the service modifies the password of the username “Service” using a win32 call NetUserSetInfo with the structure USER_INFO_{—}1003. The service then records the modification of the password in the system event log. The service then obtains a list of usernames using the win32 system call NetQueryDisplayInformation. Any usernames other than those known to be valid for the dedicated application (e.g., “Service”, “SQLAgentCmdExec”, “BOS”, etc.) are deleted using the win32 call NetUserDel. The service subsequently sets a timer to wake up in a prescribed time (e.g., 7 days) to perform the same tasks again. Also, any usernames removed can be recorded in a system event log.

The modifyPassword method performs the similar tasks that are performed when the service starts. The modifyPassword method cancels any current timer and sets a new one to wake up in a prescribed time (e.g., in 7 days).

In the illustrative example embodiment, the password generator generates a new password for the username “Service” that includes a randomly generated string of 12 characters. The encryptor encrypts the password using an algorithm similar to a one shot algorithm and writes the encrypted password to the NT registry.

A custom GINA DLL is created to act as a passthrough to the Microsoft GINA.DLL (MSGINA.DLL), for example, as discussed in MSDN. The methods that are implemented in the custom GINA DLL include WlxNegotiate and WlxLoggedOutSAS. Other methods will simply call their equivalent method in MSGINA.DLL. WlxNegotiate includes a method for performing version checking between winlogon.exe and MSGINA.DLL. WlxNegotiate is called by winlogon.exe on system startup.

WlxLoggedOutSAS includes a method called by winlgon.exe when CTRL-ALT-DEL is pressed with no users logged on. The WlxLoggedOutSAS method displays a custom logon dialog box that behaves in the same way as the standard NT logon dialog box and also contains the string, for example, “To obtain the password for the ‘Service’ account call the help desk and give the code <encrypted password>”. The encrypted password is stored in a registry. The WlxLoggedOutSAS further uses the win32 call WlxDialogBoxParam to obtain the username/password and the win32 call LogonUser to log the user on.

The dedicated application includes instructions for executing the password generator service upon start up of the dedicated application. If the password generator service does not exist or does not start up, then the programming of the dedicated application causes the dedicated application to fail.

A timer process can also be added to the dedicated application for checking every hour to ensure that the password generator service is running. If the password generator service is determined to not be running, then appropriate actions are taken to restart the password generator service. Further, a restoreLevel method can be added in the SecurityLevelControl class which calls the modifyPassword method in the password generator service anytime the security level is restored to its original value.

Accordingly, the password security method of the illustrative embodiments provides a one-time available password for use by a system service representative for accessing a stand-alone computer system running a dedicated application.

The illustrative embodiments aim to render a stand-alone computer, or group of networked computers functioning in a standalone manner, for executing a dedicated application secure while allowing service personnel access when required. The illustrative embodiments reduce the need for having a well known password for all computer systems executing a similar dedicated application. In addition, the illustrative embodiments reduce the need to remotely administer each computer and to maintain a password database. In other words, the illustrative embodiments substantially reduce the need to remotely administer password maintenance for each computer system executing the dedicated application and to maintain a corresponding password database.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures.

What is claimed is:

1. A method for maintaining a password in a computer system equipped with an operating system for running a dedicated application, comprising:
generating a password in response to an occurrence of a prescribed password generation event;
providing the generated password to an operating system security module;
producing a coded password as a function of the generated password; and
storing the coded password for use in connection with a secure operating system login access.

2. The method of claim 1, wherein providing the generated password to the operating system security module further includes overwriting a previously generated password.

3. The method of claim 1, wherein storing the coded password further includes overwriting a previously stored coded password.

4. The method of claim 1, further comprising:
displaying the stored coded password during an operating system login, wherein the displayed coded password is subject to being decoded with the use of a corresponding secure password provider, further wherein the secure operating system login is responsive to an input of a correctly decoded coded password for enabling access to the operating system as a function of the generated password and the operating system security module.

5. The method of claim 1, wherein the prescribed password generation event includes at least one selected from the group consisting of a computer system power-up; a computer system re-boot; expiration of a prescribed time duration from an immediately preceding password generation event; restoration of a security level from a modified security level to a default security level, and occurrence of a secure operating system login access.

6. The method of claim 5, wherein the modified security level of a password generation event includes at least one selected from the group consisting of a change in the security level within the dedicated application, a security level override within the dedicated application, and a one-shot security access within the dedicated application.

7. The method of claim 1, further comprising:
searching a username registry of the dedicated application upon the occurrence of the prescribed password generation event and removing any invalid usernames from the username registry.

8. The method of claim 7, further comprising:
reviewing privileges associated with respective valid usernames in the username registry and resetting the privileges of the respective valid username to prescribed default settings.

9. The method of claim 1, wherein generating the password includes generating the password for a prescribed username.

10. The method of claim 9, wherein the prescribed username includes a service username.

11. The method of claim 1, wherein the dedicated application includes a point of sale application in a fuel dispensing environment.

12. The method of claim 1, wherein the computer system includes at least one selected from the group consisting of a stand-alone computer system and a stand-alone network of computer systems.

13. A computer system having a password maintenance capability comprising:
an operating system including an operating system security module, an operating system data store module, and an operating system login module, said operating system operable for executing a dedicated application; and
a password security generator including a password generator and a password encryptor, wherein
the password generator couples with said operating system for generating a password in response to an occurrence of a prescribed password generation event, the password generator providing the generated password to the operating system security module, and
the password encryptor couples to the password generator for producing a coded password as a function of the generated password, the password encryptor providing the coded password to the operating system data store module for use in connection with a secure operating system login access via the operating system login module.

14. The computer system of claim 13, wherein further the password generator provides the generated password to the operating system security module and overwrites a previously generated password.

15. The computer system of claim 13, wherein further the password encryptor stores the coded password and overwrites a previously stored coded password.

16. The computer system of claim 13, further comprising:
means for displaying the stored coded password during an operating system login, wherein the displayed coded password is subject to being decoded with the use of a corresponding secure password provider, further wherein the operating system login module is responsive to an input of a correctly decoded coded password for enabling access to said operating system as a function of the generated password and the operating system security module.

17. The computer system of claim 13, wherein the prescribed password generation event includes at least one selected from the group consisting of a computer system power-up; a computer system re-boot; expiration of a prescribed time duration from an immediately preceding password generation event; restoration of a security level from a modified security level to a default security level, and occurrence of a secure operating system login access.

18. The computer system of claim 17, wherein the modified security level of a password generation event includes at least one selected from the group consisting of a change in the security level within the dedicated application, a security level override within the dedicated application, and a one-shot security access within the dedicated application.

19. The computer system of claim 13, further wherein said password security generator further includes means responsive to an occurrence of a prescribed password generation event for searching a username registry of the dedicated application and removing any invalid usernames from the username registry.

20. The computer system of claim 19, further wherein the searching means reviews privileges associated with respective valid usernames in the username registry and resets the privileges of the respective valid username to prescribed default settings.

21. The computer system of claim 13, wherein the password generator generates the password for a service username.

22. The computer system of claim 13, wherein the dedicated application includes a point of sale application in a fuel dispensing environment.

23. The computer system of claim 13, wherein said computer system includes at least one selected from the group consisting of a stand-alone computer system and a stand-alone network of computer systems.

24. A computer program product for maintaining a password in a computer system equipped with an operating system for running a dedicated application, comprising:
a computer program processable by a computer system for causing the computer system to:
generate a password in response to an occurrence of a prescribed password generation event,
provide the generated password to an operating system security module,
produce a coded password as a function of the generated password, and
store the coded password for use in connection with a secure operating system login access; and
apparatus from which the computer program is accessible by the computer system.

25. The computer program product of claim 24, wherein said computer program is further processable by the computer system for causing the computer system to:
display the stored coded password during an operating system login, wherein the displayed coded password is subject to being decoded with the use of a corresponding secure password provider, further wherein the secure operating system login is responsive to an input of a correctly decoded coded password for enabling access to the operating system as a function of the generated password and the operating system security module.

26. The computer program product of claim 24, wherein the prescribed password generation event includes at least one selected from the group consisting of a computer system power-up; a computer system re-boot; expiration of a prescribed time duration from an immediately preceding password generation event; restoration of a security level from a modified security level to a default security level, and occurrence of a secure operating system login access.

27. The computer program product of claim 26, wherein the modified security level of a password generation event includes at least one selected from the group consisting of a change in the security level within the dedicated application, a security level override within the dedicated application, and a one-shot security access within the dedicated application.

28. The computer program product of claim 24, wherein said computer program is further processable by the computer system for causing the computer system to:
search a username registry of the dedicated application upon the occurrence of the prescribed password generation event and remove any invalid usernames from the username registry, and
review privileges associated with respective valid usernames in the username registry and reset the privileges of the respective valid usernames to prescribed default settings.

29. The computer program product of claim 24, wherein generating the password includes generating the password for a service username.

30. The computer program product of claim 24, wherein the dedicated application includes a point of sale application in a fuel dispensing environment.
